(19) United States
(12) Patent Application Publication
(10) Pub. No.: US 2016/0207046 A1
(43) Pub. Date: Jul. 21, 2016

(54) Carrier for Biological Materials

(71) Applicant: Mark J. Hrutkay, Washington, PA (US)

(72) Inventor: Mark J. Hrutkay, Washington, PA (US)

(21) Appl. No.: 15/000,571

(22) Filed: Jan. 19, 2016

Related U.S. Application Data
(60) Provisional application No. 62/104,335, filed on Jan. 16, 2015.

(51) Int. Cl. B01L 9/00; B65G 67/24

(52) U.S. Cl. CPC B01L 9/00; B65G 67/24; B01L 2200/18; B01L 2300/0832; B01L 2300/0809; B01L 2200/087

(57) ABSTRACT

Provided herein is a carrier device for the safe and efficient transportation and transfer of biological materials. The carrier device includes a frame comprising a rear section and a bottom section, a swivel member attached to the frame, and a container attached to the swivel member. The container is rotatable with respect to the frame to float to a level regardless of an orientation of the frame.

### CROSS REFERENCE TO RELATED APPLICATIONS

The present application claims the benefit of U.S. Provisional Patent Application No. 62/104,335, filed on Jan. 16, 2015, the entire disclosure of which is hereby incorporated by reference.

### BACKGROUND OF THE INVENTION

1. Field of the Invention

The present disclosure relates generally to a transportation and transfer device. More particularly, it relates to a handcart for use in the safe and efficient transportation of dewar tanks, and a mechanism for reducing user risk upon pouring liquid nitrogen from the tank to a different container.

2. Description of Related Art

The ability to maintain temperatures far below the freezing point of water makes liquid nitrogen extremely useful in a wide range of applications, including biotechnical processes. Scientists and clinical practitioners often find it necessary to genetically stabilize biological samples and materials to preserve the integrity of complex molecules for storage and transport.

Advances in cryopreservation technology have led to methods that allow low-temperature maintenance of a variety of cell types and molecules. Techniques are now available for the cryopreservation of cultures of viruses and bacteria, isolated tissue cells in tissue culture, small multicellular organisms, enzymes, human and animal DNA, pharmaceuticals including vaccines, diagnostic chemical substrates, and more complex organisms such as embryos, unfertilized oocytes, and spermatozoa. To maintain viability, these biological materials must be transported or shipped in a frozen state. This requires a shipping enclosure that can maintain a cryogenic environment for an extended period of time while being relatively impervious to mechanical shock.

Accordingly, tissue specimens are transported in dewar tanks, specialized vacuum flasks adapted to store cryogen liquids, such as liquid nitrogen, helium, and neon for extended periods of time. However, the current method in which dewar tanks are transported has several drawbacks and associated user risks.

No dewar tank can provide perfect thermal insulation, thus the cryogenic liquid will gradually boil, producing an enormous quantity of gas. The expansion ratios of cryogenic gasses (Nitrogen 1 to 696, Helium 1 to 757, and Neon 1 to 1438) create extreme pressure within the sealed container. To minimize the risk of explosion and serious injury, design precautions must be taken. The simplest of dewar tanks allow gas to escape through an open top or through a loose-fitting stopper. Consequently, dewar vessels are least dangerous and most efficient when in a vertically upright position.

Moreover, the extreme temperatures of cryogenic liquids can cause severe cold burns if the liquid contacts the user's skin. Maintaining an upright position of the dewar tank not only avoids spillage and the loss of contents, which would shorten the duration in which the container is able to maintain its cryogenic environment, but also significantly reduces the user' s risk of liquid nitrogen burns during transportation.

Cold burns also present a significant risk to users when the contents of the vessel are transferred from the dewar tank or original transporting container to a second container when the material has reached its destination. Users operating in biotechnical fields, such as research laboratories or hospital settings, frequently use smaller quantities of cryogenic liquids and thus, often pour the contents from the transportation container directly into a second container.

Hand carrying is one method by which dewar tanks are currently transported. Because the materials used in the construction of the tanks are relatively dense, hand carrying the heavy containers can be a tiresome and inefficient process. As a result, users have placed dewar tanks on standard handcart dollies, and in doing so, users exchange convenience for safety and effectiveness. Handcarts and other wagon or cart type transport devices are not designed to carry liquid nitrogen tanks as significant safety risks and inefficiency problems arise when the tank is tilted away from a vertically upright position.

Thus, it is desirable to create a device capable of stabilizing a container in a vertically oriented position throughout the transportation process, coupled with a mechanism for reducing the risks associated with transferring and pouring the contents from a dewar tank to a second container.

### SUMMARY OF THE INVENTION

The present invention ensures a container carried by the device will remain in a stable, vertically oriented position throughout the transportation process, while reducing the labor efforts of a user.

The present invention discloses a carrier device for the safe and efficient transportation and transfer of biological materials. The carrier device includes, a frame comprising a rear section and a bottom section, a swivel member attached to the frame, and a container attached to the swivel member. The container is rotatable with respect to the frame, to float to a level as the swivel member is rotatable with respect to the frame, and/or the container is rotatable with respect to the swivel member.

In one embodiment, the rear section includes two opposing members spaced a distance apart. The distance the opposing members are spaced apart is greater than the width of the container permitting the container to swing between the two opposing members. The bottom section of the carrier device includes a foot member for stabilizing the carrier device when the frame is in an upright position.

In one embodiment, the frame includes a support member to which the swivel member is attached. The support member may be positioned substantially perpendicular to the rear section and/or substantially perpendicular to the bottom section. The swivel member is secured to the container at a position along a vertical plane extending through a center of gravity of the holding. The swivel member may be cylindrically shaped and at least a portion of the swivel member is coated in a lubricant to facilitate rotation.

To facilitate movement from a first location to a second location, the frame of the carrier device includes a handle and an axle having a plurality of wheels. To facilitate transfer of the biological materials the container includes a handle. The container may be shaped cylindrically or shaped as a rectangular prism with or without a top.

A method of transporting and transferring a tank containing biological materials is also provided herein. The method includes placing the tank in a container, wherein the container is attached to a swivel member and the swivel member is attached to a frame, allowing the container to float to a level, tilting the frame with respect to a ground surface, and moving the frame from a first location to a second location. The tank remains vertically oriented from a time the container floats to the level to a time the frame reaches the second location. At the second location a user may pour the biological materials from the tank by grasping a handle provided on the container.

Further details and advantages will be understood from the following detailed description read in conjunction with the accompanying drawings.

### BRIEF DESCRIPTION OF THE DRAWINGS

The present invention is described in further detail with reference to the accompanying figures, in which:

FIG. 1 is a top plan view of an embodiment of the carrier device made in accordance with the present invention;

FIG. 2 is a front view of the carrier device of FIG. 1;

FIG. 3 is a rear view of the carrier device of FIG. 1; and

FIG. 4 is a left-side view of the carrier device of FIG. 1.

### DETAILED DESCRIPTION OF THE DISCLOSURE

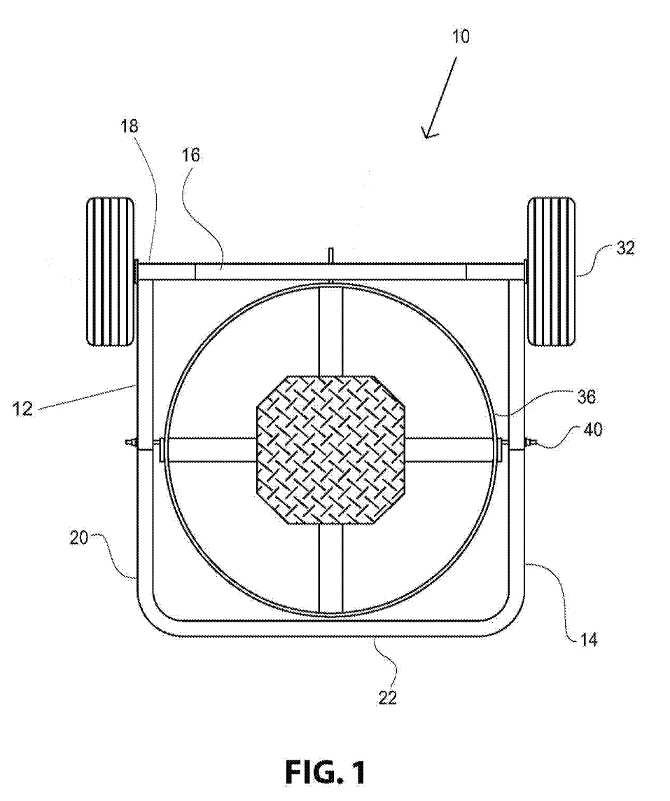

The carrier device of the present invention safeguards that a tank carried by the device 10 will remain in a stable, vertically oriented position throughout the transportation process. As shown in FIGS. 1-4, a carrier device 10 includes a rigid metal frame 12 that may be constructed of solid or tubular metal. The frame 12 is defined by a bottom section 14, a rear section 16, and an axle 18. The components of the frame 12 may be manufactured as one continuous part or separate parts to be subsequently connected.

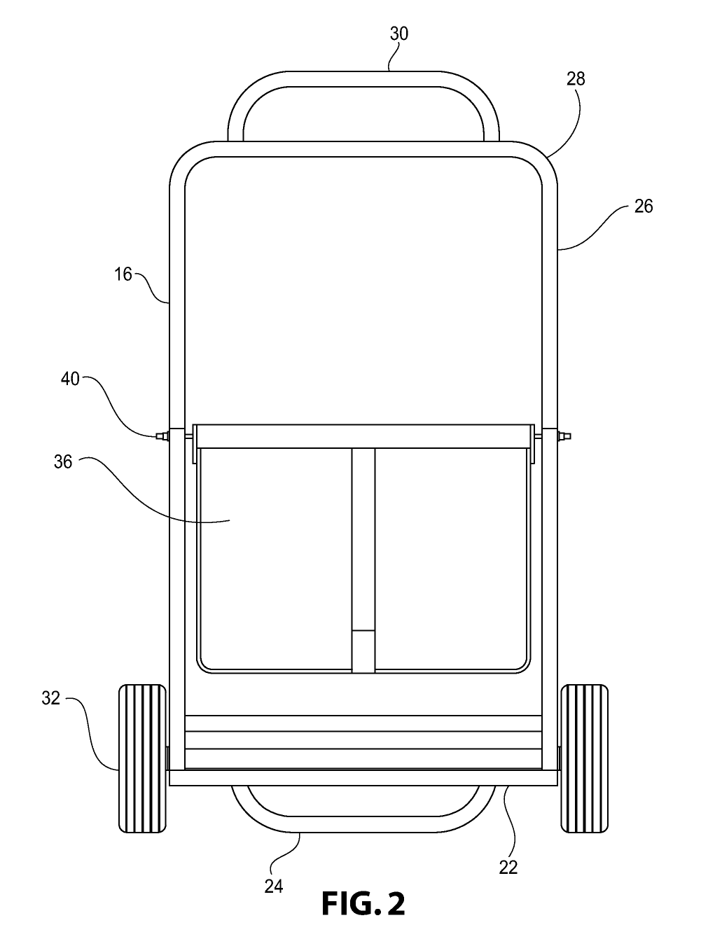

With specific reference to FIGS. 1 and 2, the bottom section 14 is formed by two bottom opposing members 20 of equal lengths, extending parallel to each other from the rear section 16. The two bottom opposing members 20 are curved towards each other at a predetermined length to form a front connecting member 22. Alternatively, a separate front connecting member 22 may be secured between the bottom opposing members 20. Cross members or a solid metal surface (neither are shown) may optionally be added between the bottom opposing members 20 to add rigidity and strength to the bottom section 14. A foot 24 is secured to the bottom of the front connecting member 22 to raise the bottom section 14 off of a ground surface and to stabilize the frame 12 in a vertically oriented position when the foot 24 is pressed against the ground. The foot 24 may be constructed from the same tubular or solid metal as the frame. The foot 24 may be multiple single pieces protruding substantially perpendicular from the bottom of the bottom section 14 downward towards the ground surface, or one tubular metal member so long as the foot 24 rests flat on the ground surface when the frame 12 is in its vertically upright position.

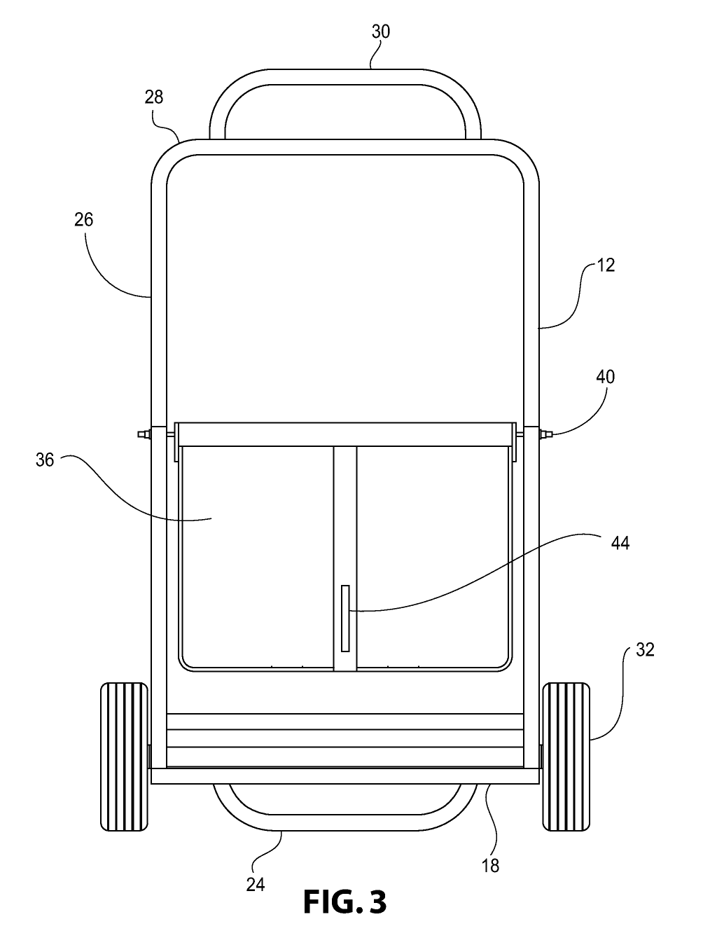

As shown in FIG. 3, the rear section 16 is formed by two rear opposing members 26 of equal lengths, extending upwardly from the bottom section 14 and terminating at a predetermined height. The rear opposing members 26 generally form an orthogonal angle to the bottom section 14. The two rear opposing members 26 may be curved towards each other at the predetermined height to form a top connecting member 28. Alternatively, a separate top connecting member 28 may be secured between the rear opposing members 26. Although the top connecting member 28 may be used to move and steer the carrier device 10, an additional handle 30, may optionally be secured to the top of the top connecting member 28 to improve user handling and comfort.

With continued reference to FIG. 3, two wheels 32 are attached to the axle 18. The wheels 32 are pneumatic and of a sufficiently large diameter to accommodate variations in the topology of the ground surface to facilitate movement of the carrier device 10 from a first location to a second location. The wheels are, for example, 9.5 inches in diameter.

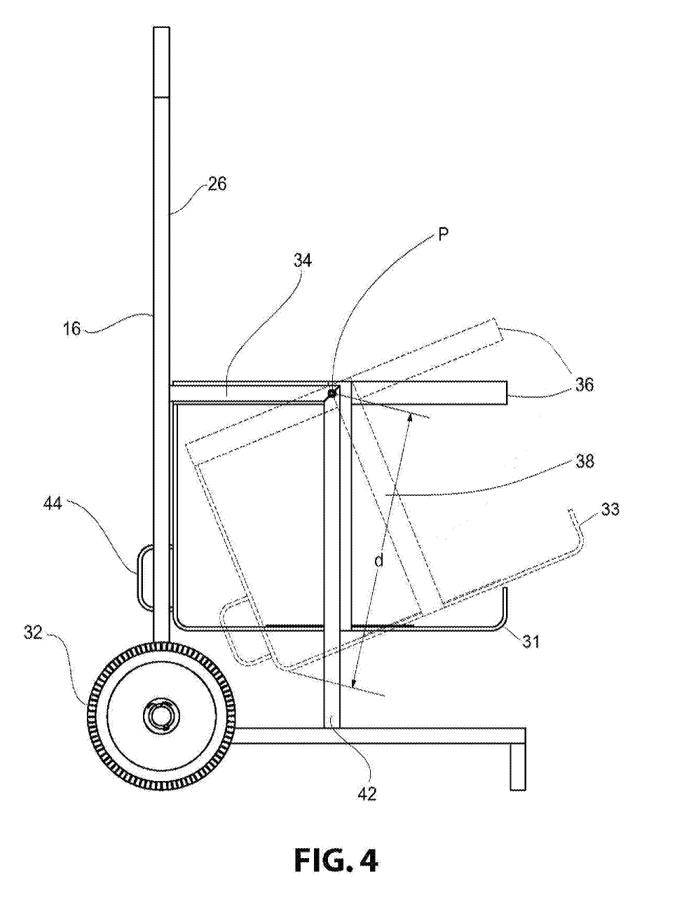

As shown in FIG. 4, vertical support members 42 are secured to the top of each bottom opposing members 20, forming an orthogonal angle thereto at an equidistant length from the rear section 16. The vertical support members 42 are provided approximately in the center of each bottom opposing member 20, so that a holding mechanism, i.e., a container 36, will be substantially centered over the bottom section 14 when the rear section 16 of the carrier device 10 is in a vertically oriented position. The two vertical support members 42 are preferably of equal length and extend upwardly to a predetermined height. The vertical support members 42 may be made from the same tubular or solid metal as the frame 12, or from any other rigid material.

With continued reference to FIG. 4, two horizontal support members 34 are secured to the front of the rear opposing members 26, forming an orthogonal angle thereto, at the same predetermined height. The predetermined height is of sufficient height to permit the container 36 to rotate from a first position 31 to a second position 33 without contacting the bottom section 14 regardless of the vertical orientation of the frame 12. The horizontal support members 34 are of equal length.

As shown in FIG. 1, a swivel member 40 is secured between the horizontal support members 34 and/or the vertical support members 42. The container 36 is preferably attached to swivel member 40 at a location substantially centered over the bottom section 14 when the rear section 16 of the carrier device 10 is in its vertically upright position. In a preferred embodiment, the carrier device 10 provides both vertical support members 42 and horizontal support members 34, although it is understood that the support members may be provided in the alternative.

The swivel member 40 extends through the support members at the location where the horizontal support member 34 intersect the vertical support members 42 in a manner that permits the swivel member 40 to rotate. The swivel member 40 must be located at a sufficient height above the bottom section 14 to permit the container 36 to rotate without contacting the bottom section 14. Accordingly, with specific reference to FIG. 4, the bottom of the swivel member 40 is located at a height above the bottom section 14 that is of greater length than d, defined as the distance between the point in which the swivel member 40 contacts the container 36 and a bottom corner of the container 36.

In another embodiment, the swivel member may also be rotationally secured to the support members 34 and 42 with a ball and socket formation. The ends of the swivel member 40 may be spherically shaped and adapted to be inserted into similarly sized and shaped sockets that are impressed on the insides of the swivel support members 34 and or 42. It is noted that the swivel member 40 may be secured to the two horizontal swivel support members 34 by any means that permits the swivel member 40 to swivel or rotate freely, while securing it in place between the support members 34 and 42. The swivel member 40 may be of any shape including cylindrical and may be constructed from any rigid material, such as the metal of frame 12. Additionally, at least the edges, where the swivel member 40 attaches to the frame 12, may be coated with a lubricating agent to facilitate rotation.

The swivel member 40 to which the container 36 is attached rotates relative to the frame and causes the container 36 to float to level when the frame is reoriented. As used within this disclosure, float to level means to maintain a vertically oriented position regardless of the angle between the rear section 16 and aground surface (not shown). The container 36 is preferably a basket adapted to hold dewar tanks and like containers carrying biological material. The container 36 may be cylindrically shaped or shaped as a rectangular prism with or without a top portion.

The swivel member 40 is securely attached to both sides of the container 36 in positions that, if extended through the container 36 the swivel member 40 would pass through either the holding mechanism's center of gravity 38, or at a location above the container's center of gravity 38, and along a vertical plane passing through the center of gravity 38. Both the swivel member 40 and the container 36 will rotate simultaneously with respect to the frame 12 causing the container 36 to float to level.

As shown in FIGS. 3 and 4, a pouring handle 44 is connected to the container 36 on a rear or user side of the container 36. The pouring handle 44 is preferably loop shaped, and constructed from the same rigid material as the frame 12, with enough interior space to allow a user to comfortably grab the handle 44 and pull it between the rear opposing members 26, or push it forward to manually tilt the container 36 against gravitational forces to pour and transfer the contents of the dewar tank or like container.

A method of transporting and transferring a tank containing biological materials, is also provided herein. The method includes a user placing a dewar tank or a similar tank containing biological materials into the container 36 of the carrier device previously described. The user then allows the container 36 to float to a level, tilts the frame 12 with respect to a ground surface, and wheels the device from a first location 31 to a second location 33. The tank floats to a level regardless of the vertical orientation of the frame 12 and remains vertically upright throughout the transportation process. At the second location, the user may use the pouring handle 44 to tilt the container 36 and pour the biological material from the tank.

While several configurations of the carrier device 10 are described hereinabove in detail, other configurations and embodiments will be apparent to, and readily made by, those skilled in the art without departing from the scope and spirit of the disclosure. For example, it is to be understood that this disclosure contemplates that, to the extent possible, one or more features of any embodiment can be combined with one or more features of any other embodiment. Accordingly, the foregoing description is intended to be illustrative rather than restrictive.

We claim:

1. A carrier device for the transportation and transfer of a tank containing biological materials, comprising:
a frame comprising a rear section and a bottom section,
a swivel member attached to the frame, and
a container attached to the swivel member, wherein the container is rotatable with respect to the frame to float to a level.

2. The carrier device of claim 1, further comprising an axle attached to the frame.

3. The carrier device of claim 2, further comprising a plurality of wheels attached to the axle.

4. The carrier device of claim 1, wherein the swivel member is rotatable with respect to the frame.

5. The carrier device of claim 1, wherein the container is rotatable with respect to the swivel member.

6. The carrier device of claim 1, wherein the frame further comprises a support member, and wherein the swivel member is attached to the support member.

7. The carrier device of claim 6, wherein the support member is positioned substantially perpendicular to the rear section.

8. The carrier device of claim 6, wherein the support member is positioned substantially perpendicular to the bottom section.

9. The carrier device of claim 1, wherein the rear section comprises two opposing members, and wherein the two opposing members are spaced a distance apart.

10. The carrier device of claim 9, wherein the distance the two opposing members are spaced apart is greater than the width of the container permitting the container to pivot between the two opposing members when the frame is tilted.

11. The carrier device of claim 1, wherein the bottom section further comprises a foot member for stabilizing the carrier device when the frame is in an upright position.

12. The carrier device according to claim 1, wherein the swivel member is secured to the container at a position along a vertical plane extending through a center of gravity of the container.

13. The carrier device of claim 1, wherein the swivel member is cylindrically shaped.

14. The carrier device of claim 1, wherein at least a portion of the swivel member is coated in a lubricant.

15. The carrier device of claim 1, wherein the container further comprises a handle.

16. The carrier device of claim 1, wherein the container is cylindrically shaped.

17. The carrier device according to claim 1, wherein the container is shaped as a rectangular prism.

18. The carrier device of claim 1, wherein the frame further comprises a handle.

19. A method of transporting and transferring a tank containing biological materials, comprising the steps of:
placing the tank in a container, wherein the container is attached to a swivel member and the swivel member is attached to a frame,
allowing the container to float to a level,
tilting the frame with respect to a ground surface,
moving the frame from a first location to a second location, wherein the tank remains vertically oriented from a time the container floats to the level to a time the frame reaches the second position.

20. The method of claim 19, further comprising tilting the container and pouring the biological materials from the tank.
